(19) United States
(12) Patent Application Publication
(10) Pub. No.: US 2022/0010109 A1
(43) Pub. Date: Jan. 13, 2022

(54) COAGULATABLE MIXTURE FOR SEALING A TIRE PUNCTURE

(71) Applicant: Alfonso Garcia de Arboleya Fernandez, Selma, TX (US)

(72) Inventor: Alfonso Garcia de Arboleya Fernandez, Selma, TX (US)

(21) Appl. No.: 17/294,136

(22) PCT Filed: Nov. 12, 2019
(86) PCT No.: PCT/US2019/060898

§ 371 Date: May 14, 2021

Related U.S. Application Data
(60) Provisional application No. 62/768,737, filed on Nov. 16, 2018.

(51) Int. Cl. C08L 21/02; B29C 73/16; B60C 19/12

(52) U.S. Cl. CPC C08L 21/02; B29C 73/163; C08L 2201/52; C08L 2207/20; C08L 2205/14; B60C 19/122

(57) ABSTRACT

Various embodiments of the present disclosure relate to a coagulatable mixture. The coagulatable mixture includes a solvent component; an antifreeze component; a latex component; and a solid filler component.

### CROSS-REFERENCE TO RELATED APPLICATION

This application claims the benefit of priority to U.S. Provisional Patent Application Ser. No. 62/768,737 entitled “COAGULATABLE MIXTURE FOR SEALING A TIRE PUNCTURE,” filed Nov. 16, 2018, the disclosure of which is incorporated herein in its entirety by reference.

### BACKGROUND

Tires are used on a wide variety of vehicles. When a puncture is formed in a tire, particularly at high speed, there is a danger that the vehicle will become uncontrollable or at least inoperable. To allow a vehicle to reach a location where the tire can be repaired, it may be desirable to seal the puncture as soon as possible.

### SUMMARY OF THE DISCLOSURE

Various embodiments of the present disclosure relate to a 20 coagulatable mixture. The coagulatable mixture includes a solvent component; an antifreeze component; a latex component; and a solid filler component.

Various embodiments of the present disclosure further relate to a coagulatable mixture. The coagulatable mixture includes water, propylene glycerol, a latex dispersion, and particulate Zea mays.

Various embodiments of the present disclosure further relate to a method of making a coagulatable mixture. The coagulatable mixture includes a solvent component; an antifreeze component; a latex component; and a solid filler component. The method includes mixing the solvent component; the antifreeze component; the latex component; and the solid filler component.

Various embodiments of the present disclosure further relate to a tire including a coagulatable mixture. The coagulatable mixture includes a solvent component; an antifreeze component; a latex component; and a solid filler component.

Various embodiments of the present disclosure further relate to a method of using a tire including a coagulatable mixture. The coagulatable mixture includes a solvent component; an antifreeze component; a latex component; and a solid filler component. The method includes coagulating the coagulable mixture about one or more punctures in the tire.

Various embodiments of the present disclosure further relate to a method of making a tire including a coagulatable mixture. The coagulatable mixture includes a solvent component; an antifreeze component; a latex component; and a solid filler component. The method includes disposing a quantity of the coagulatable mixture in a space formed between the interior surface of the tire and an interior surface of the rim or an interior of the tube.

There are various advantages to using the coagulatable mixtures described herein. For example, according to various embodiments of the present disclosure, the coagulatable mixture is capable of sealing one or more punctures rapidly before too much air can escape the tire. According to various embodiments, the coagulatable mixture is capable of sealing one or more punctures having a wide variety of dimensions. According to various embodiments, the coagulatable mixture is capable of sealing a puncture to such a degree that the tire can be used for a suitable distance to bring a vehicle to a safe location. According to various embodiments, the coagulatable mixture can be free of a corrosive compound that would corrode or damage a tire, rim, or sensor (e.g., air pressure sensor). According to various embodiments, the coagulatable mixture is very stable over a long period of time and does not need to be replaced regularly once disposed in the tire. According to various embodiments, the coagulatable mixture is capable of being evenly distributed about the tire such that the tire does not become unbalanced. According to various embodiments, the coagulatable mixture is mixed before being supplied to the tire, thus allowing the coagulatable mixture to be used instantaneously upon formation of one or more punctures in the tire.

### BRIEF DESCRIPTION OF THE FIGURES

The drawings illustrate generally, by way of example, but not by way of limitation, various embodiments discussed in the present document.

FIG. 1 is a cross sectional view of a tire assembly including a coagulatable mixture, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 900%, 95%, 96%, 97%, 98%, 99%, 99.5%, 99.9%, 99.99%, or at least about 99.999% or more, or 100%.

Various embodiments of the present disclosure relate to a coagulatable mixture that can be used to rapidly seal one or more punctures in a tire. The coagulatable mixture can be included in a tire in an uncoagulated state and then upon formation of a puncture at least a portion of the coagulatable mixture can rapidly gather at the puncture site, coagulate, and stop the flow of air exiting the tire. This can allow the user of the tire to continue to use the tire for a longer amount of time, which may be sufficient to allow the user to have the tire repaired or replaced.

In operation, tire punctures can happen in many different ways. For example, a car tire can be punctured by running over a nail or other debris on a road. A bicycle tire can be punctured by a sharp rock on a trail. An aircraft tire can be punctured by debris on a runway or tarmac. However the puncture or punctures are formed, the result can be for the air in the tire to rapidly exit the tire, resulting in a flat tire and potentially momentarily loss of control of the vehicle. The instantly described coagulatable mixture, however, is capable of rapidly sealing the puncture or punctures to substantially prevent or delay formation of a flat tire.

Various embodiments of the coagulatable mixture include a solvent component, an antifreeze component, a latex component, and a solid filler component. These components can exist as a mixture with no components isolated from each other. The mixture can be a homogenous or heterogeneous mixture. The coagulatable mixture can be evenly distributed about an interior of a tire, thus increasing the ability of the mixture to be rapidly deployed to the puncture site.

The solvent can be any solvent that is capable of accommodating the components of the mixture. The solvent should not be one that is capable of reacting with the material of the tire, rim, or any sensors disposed within the tire (e.g., an air pressure sensor). Examples of suitable solvents include aqueous or organic solvents. Examples of organic solvents include turpentine, xylene, and a mixture thereof. Examples of aqueous solvents include water, ammonia, or a mixture thereof. The solvent component can be in any weight percentage (wt %) of the coagulatable mixture. For example, the solvent component can be in a range of from about 20 wt % to about 80 wt % of the coagulatable mixture, about 40 wt % to about 60 wt %, less than, equal to, or greater than about 20 wt %, 25, 30, 35, 40, 45, 50, 55, 60, 65, 70, 75, or about 80 wt % of the coagulatable mixture.

The antifreeze component can help to ensure that the coagulatable mixture will not freeze at certain temperatures at which the tires are used. For example, automobile tires may be used in northern climates during the winter where they may be exposed to temperatures that are capable of freezing the coagulatable mixture, absent the antifreeze component. Alternatively, if the coagulatable mixture is deployed in an aircraft tire, the aircraft may be at high altitudes for extended periods of time where the ambient temperature is capable of freezing the coagulatable mixture. If the mixture is frozen, it may not be able to flow to the puncture in the tire.

The antifreeze component can be chosen from any antifreeze component having a desired freezing point. For example, a freezing point of the antifreeze component can be in a range of from about −40° C. to about 5° C., about −30° C. to about 0° C., less than, equal to, or greater than about −40° C., −35, −30, −25, −20, −15, −10, −5, or about 0° C. Examples of suitable antifreeze components include methanol, glycerol, ethylene glycol, propylene glycol, propylene glycerol, or a mixture thereof. The antifreeze component can be in a range of from about 20 wt % to about 50 wt % of the coagulatable mixture, about 30 wt % to about 40 wt %, less than, equal to, or greater than about 20 wt %, 25, 30, 35, 40, 45, or about 50 wt % of the coagulatable mixture.

The latex component provides an adhesive function to the coagulatable mixture. Once a puncture is formed, the latex is able to adhere components of the mixture together and dry to form a coagulated mixture. The latex component can include a natural or synthetic rubber latex emulsion or dispersion. The latex component can further include an accelerator such as a vulcanizer, an antioxidant, an activator, a tackifier, a dithiocarbamate, a thiuram, a thiourea, a thiazol, zinc oxide, or a mixture thereof.

Examples of commercially available latex components that can be included in the coagulatable mixture can include HF-30, HX-80, HX-80LA, HX-200, HX-660, HX-874, or HX-807 all available from Holden's Latex Corp., New York, N.Y., USA. Specific selection of a latex can be driven by considerations such as the solids content of the latex component, the viscosity of latex component, whether the latex is vulcanized, or whether the latex is ammoniated. The latex component can be in a range of from about 10 wt % to about 80 wt % of the coagulatable mixture, about 20 wt % to about 40 wt %, less than, equal to, or greater than about 10 wt %, 15, 20, 25, 30, 35, 40, 45, 50, 55, 60, 65, 70, 75, or about 80 wt % of the coagulatable mixture.

The solid filler component acts to create a physical barrier for air escaping a puncture in the tire. In various embodiments, the solid filler component includes a mixture of solid filler particulate material (e.g., a collection of particles) that are able to aggregate and be held in place when the latex component is dried. A largest dimension of the individual solid filler particles can independently be in a range of from about 0.10 mm to about 5 mm, about 0.25 mm to about 0.35 mm, less than, equal to, or greater than about 0.10 mm, 0.50, 1, 1.5, 2, 2.5, 3, 3.5, 4, 4.5, or about 5 mm. Individual particles can have a precision shape (e.g., a platelet or sphere) or an irregular shape. The largest dimension can correspond to a length, diameter, width, or thickness of the individual particulate filler.

The individual particulate fillers can include many suitable materials. For example, the individual particles can include a natural material, a synthetic material, or a combination thereof. For example, individual particulate fillers can include natural rubber, synthetic rubber, poly-praraphenylene terephtalamide, Zea mays, mica, piperaceae, glitter, coffea, talc, or a mixture thereof. In embodiments where individual particulate fillers include natural or synthetic rubber, the rubber can be a recycled rubber. The solid filler component can be in a range of from about 20 wt % to about 80 wt % of the coagulatable mixture, about 40 wt % to about 60 wt %, less than, equal to, or greater than about 20 wt %, 25, 30, 35, 40, 45, 50, 55, 60, 65, 70, 75, or about 80 wt % of the coagulatable mixture.

The coagulatable mixture can include any further components that may be necessary or desirable. For example, the coagulatable mixture can include a plurality of ceramic beads. If present, the ceramic beads can function to evenly distribute the coagulatable mixture about the interior of the tire. This can help to ensure that at least a majority of the solid filler component particles remain suspended in the mixture. For example, the ceramic beads can be of a sufficient mass that they can dislodge and move the coagulatable mixture to prevent the coagulatable mixture from agglomerating at a particular location. A largest dimension of the individual ceramic beads can independently be in a range of from about 0.10 mm to about 5 mm, about 0.25 mm to about 0.35 mm, less than, equal to, or greater than about 0.10 mm, 0.50, 1, 1.5, 2, 2.5, 3, 3.5, 4, 4.5, or about 5 mm. Individual ceramic beads can have a precision shape (e.g., a platelet or sphere) or an irregular shape. The largest dimension can correspond to a length, diameter, width, or thickness of the individual particulate filler. Although ceramic materials are described, any other solid particle that is capable of mixing the coagulatable mixture may be included. The ceramic beads can include a material chosen from an alpha-alumina, a fused aluminum oxide, a heat-treated aluminum oxide, a ceramic aluminum oxide, a sintered aluminum oxide, a silicon carbide, a titanium diboride, a boron carbide, a tungsten carbide, a titanium carbide, a diamond, a cubic boron nitride, a garnet, a fused alumina-zirconia, a sol-gel derived abrasive particle, a cerium oxide, a zirconium oxide, a titanium oxide, and combinations thereof.

The coagulatable mixture can be tuned to have many desirable properties. For example, the pH of the coagulatable mixture can have a neutral or only slightly acidic or basic value. For example, a pH of the coagulatable mixture can be in a range of from about 6 to about 8 or can be about 7. Controlling the pH of the coagulatable mixture can help to mitigate the risk that the coagulatable mixture will destroy or corrode the tire, or any component thereof such as a tire pressure sensor. The risk of corrosion can be further mitigated by not including certain corrosive components such as ammonium nitrate.

The coagulatable mixture can be made according to any suitable method. For example, each of the solvent component, the latex component, the antifreeze component, and the solid filler component, as well as any further optional components, can be mixed before being disposed in a tire. This in in direct contrast to other mixtures in which the components are not mixed before they are put in a tire.

In some embodiments, the components of the mixture can be mixed in a particular order. For example, the latex component can be added to the mixture after the solvent component, and the antifreeze component can be added after the latex component. Adding the components in this order may be advantages when the antifreeze component includes propylene glycerol, propylene glycol. This is because propylene glycerol will generate foam if it is mixed with or before water and latex.

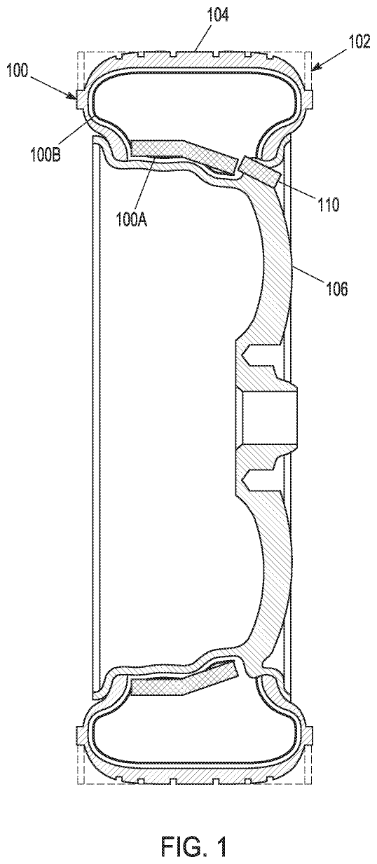

The coagulatable mixture can be a component of a tire or tire assembly. For example, FIG. 1 shows an embodiment where coagulatable mixture 100 is a component of tire assembly 102. Tire assembly 102 includes tire 104 and rim 106. Tire 104 is attached to rim 106 and space 108 is defined therebetween. Space 108 holds air (e.g. compressed air) and is where coagulatable mixture 100 is located. Air, and in some embodiments, coagulatable mixture 100 is supplied to space 108 via valve 110. As shown in FIG. 1, tire 104 is an automobile tire (e.g., a tire for a car, van, sport-utility vehicle, truck, or the like). However, tire 104 can be one of many other types of tires such as a trailer tire, motorcycle tire, bicycle tire, or an aircraft tire. Tire 104 is shown as a tubeless tire, but in further embodiments, tire 104 can be a tube tire.

As generally understood, a tire can refer to a ring-shaped component that surrounds rim 106 to transfer a vehicle's load from the axle through the wheel to the ground and to provide traction on the surface traveled over. Most tires, such as those for automobiles and bicycles, are pneumatically inflated structures, which also provide a flexible cushion that absorbs shock as the tire rolls over rough features on the surface. Tires provide a footprint that is designed to match the weight of the vehicle with the bearing strength of the surface that it rolls over by providing a bearing pressure that will not deform the surface excessively.

The materials of pneumatic tires can include synthetic rubber, natural rubber, fabric and wire, along with carbon black and other chemical compounds. The can include a tread and a body. The tread provides traction while the body provides containment for a quantity of compressed air. Pneumatic tires are used on many types of vehicles, mentioned herein including cars, bicycles, motorcycles, buses, trucks, heavy equipment, and aircraft. Pneumatic tires can also be used in various non-automotive applications, such as some casters, carts, lawnmowers, and wheelbarrows.

Rim 106 can include any suitable material. General considerations for rim 106 include the strength of the material and in some circumstances the weight of the material. Examples of suitable materials that the rim can include are a metal, a plastic, a composite, or a mixture thereof. Examples of suitable metals include chrome, aluminum, iron, mixtures thereof, or alloys thereof. Examples of suitable composites include a carbon fiber, graphite, graphene, or mixtures thereof. Rim 106 can include components such as air valve 110, which allow compressed air to be delivered to space 108. Rim 106 can further include a sensor that can transmit data relating the air pressure in space 108, the rotations per minute of tire 104, the balance of tire 104, or any other desired property.

As shown in FIG. 1, tire 104 has coagulatable mixture 100 disposed therein. Coagulatable mixture can exist as a liquid 100A as a film 100B, or a first portion of coagulatable mixture 100 can be liquid 100A and a second portion can be film 100B. Each portion can independently range from about 10 wt % to about 99 wt % of the mixture, about 20 wt % to about 50 wt %, less than, equal to, or greater than about 10 wt %, 15, 20, 25, 30, 35, 40, 45, 50, 55, 60, 65, 70, 75, 80, 85, 90, 95, or about 99 wt % of the mixture. As shown, coagulatable mixture 100 is distributed about an internal surface of tire 104 and rim 106 in a substantially uniform manner. As a result of the uniform distribution, it is more likely that if a puncture in the tire is formed the coagulatable mixture can be brought into contact with and seal the puncture relatively quickly.

Coagulatable mixture 100 can be incorporated into tire 104 at the time the tire 104 is manufactured or after tire 104 is attached to rim 106. In embodiments in which coagulatable mixture 100 is added after tire 104 is attached to rim 106, coagulatable mixture 100 may be injected into space 108 via air valve 110. After coagulatable mixture 100 is disposed in space 108, tire 104 is rotated to evenly distribute coagulatable mixture 100 about the interior surface of tire 104, rim 106, or both. To ensure adequate dispersion, tire 104 can be rotated for any suitable amount of time. For example, tire can be rotated for about 0.5 minutes to about 240 minutes, about, 1 minute to about 20 minutes, less than, equal to, or greater than about 0.5 minutes, 1, 5, 10, 15, 20, 25, 30, 35, 40, 45, 50, 55, 60, 65, 70, 75, 80, 85, 90, 95, 100, 105, 110, 115, 120, 130, 135, 140, 145, 150, 155, 160, 165, 170, 175, 180, 185, 190, 200, 205, 210, 215, 220, 225, 230, 235, or about 240 minutes. Tire 104 can be rotated at about 2 to about 60 miles per hour (MPH) about 20 mph to about 40 mph, less than, equal to, or greater than about 2 mph, 5, 10, 15, 20, 25, 30, 35, 40, 45, 50, 55, about 60 mph, or in excess of 20 mph. Following rotation, coagulatable mixture 100 is evenly distributed about tire 104. At least a portion of coagulatable mixture 100 is evenly distributed about the interior surface of tire 104 and rim 106, respectively as film 100B. Liquid portion 100A will be evenly distributed about the interior surface of tire 104 and rim 106 when tire 104 is rotated during use, when tire 104 is at rest liquid coagulatable mixture 100A may pool in one location, but will be redistributed when the tire is rotated again during use.

In operation, when a puncture is formed in tire 100, air begins to leave space 108 and flow to the exterior environment. As the air flows from space 108 the coagulatable mixture is brought with it. The solid filler component begins to catch and aggregate with each other at and about the puncture. At the same time the latex component begins to dry and act as an adhesive between the solid filler component and tire 104. Eventually enough solid filler component is aggregated and adhere about the puncture that air is no longer able to flow from space 108 to the exterior environment, thus preventing further leakage of air from tire 104.

Coagulatable mixture 100 is capable of sealing a puncture have a wide variety of major dimensions (e.g., a largest diameter, length, or width). For example, a major dimension of the puncture can be in a range of from about 0.5 mm to about 80 mm, about 2 mm to about 8 mm, less than, equal to, or greater than about 0.5 mm, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or about 80 mm. The puncture is capable of being sealed very rapidly irrespective of the size of the puncture. For example, the puncture can be sealed in about 0.5 seconds to about 5 seconds, measured from the creation of the puncture, about 1 second to about 2 seconds, less than, equal to, or greater than about 0.5 seconds, 0.75, 1, 1.25, 1.5, 1.75, 2, 2.25, 2.5, 2.75, 3, 3.25, 3.5, 3.75, 4, 4.25, 4.5, 4.75, or about 5 seconds.

Although only one puncture is described, it is within the scope of this disclosure for coagulatable mixture 100 to be capable of sealing any plural number of punctures in tire 104, whether formed simultaneously or not. The ability to rapidly seal one or more punctures of a wide variety of sizes can allow for tire 104 to be used for a great distance so that tire 104 can be brought to a repair shop for replacement or maintenance. For example, tire 104, after being sealed, can be used for about 2 miles to about 500 miles, about 50 miles to about 300 miles, less than, equal to, or greater than about 2 miles, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 miles.

Coagulatable mixture 100 can be effective for a very large amount of time after being injected into space 108. For example, coagulatable mixture 100 may not need to be replaced for an amount of time ranging from about 2 months to about 36 months, about 3 months to about 12 months, less than, equal to, or greater than about 2 months, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, or about 36 months.

### Example

Various embodiments of the present disclosure can be better understood by reference to the following Examples which are offered by way of illustration. The present disclosure is not limited to the Examples given herein.

In one example, 100 cm³ of a coagulatable mixture was formed by mixing, in order, 46.3 cm³ of water, 35.4 cm³ of propylene glycerol, and 18 cm³ of HX-200 liquid latex. The mixture was blended and 15 grams of rubber particle with an average diameter of the individual particles having a major length of about 0.33 mm.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a coagulatable mixture, the mixture comprising:
a solvent component;
an antifreeze component;
a latex component; and
a solid filler component.

Embodiment 2 provides the coagulatable mixture of Embodiment 1, wherein the solvent component is chosen from water, ammonia, turpentine, xylene, and a mixture thereof.

Embodiment 3 provides the coagulatable mixture of any one of Embodiments 1 or 2, wherein the solvent component is water.

Embodiment 4 provides the coagulatable mixture of any one of Embodiments 1-3, wherein the solvent component is in a range of from about 20 wt % to about 80 wt % of the coagulatable mixture.

Embodiment 5 provides the coagulatable mixture of any one of Embodiments 1-4, wherein the solvent component is in a range of from about 40 wt % to about 60 wt % of the coagulatable mixture.

Embodiment 6 provides the coagulatable mixture of any one of Embodiments 1-5, wherein the antifreeze component comprises methanol, glycerol, ethylene glycol, propylene glycol, propylene glycerol, or a mixture thereof.

Embodiment 7 provides the coagulatable mixture of any one of Embodiments 1-6, wherein the antifreeze component is propylene glycerol.

Embodiment 8 provides the coagulatable mixture of any one of Embodiments 1-7, wherein a freezing point of the antifreeze component is in a range of from about −40° C. to about 5° C.

Embodiment 9 provides the coagulatable mixture of any one of Embodiments 1-8, wherein a freezing point of the antifreeze component is in a range of from about −30° C. to about 0° C.

Embodiment 10 provides the coagulatable mixture of any one of Embodiments 1-9, wherein the antifreeze component is in a range of from about 20 wt % to about 50 wt % of the coagulatable mixture.

Embodiment 11 provides the coagulatable mixture of any one of Embodiments 1-10, wherein the antifreeze component is in a range of from about 30 wt % to about 40 wt % of the coagulatable mixture.

Embodiment 12 provides the coagulatable mixture of any one of Embodiments 1-11, wherein the latex component comprises a natural or synthetic rubber latex emulsion or dispersion.

Embodiment 13 provides the coagulatable mixture of Embodiment 12, wherein the latex component further comprises an accelerator, a vulcanizer, an antioxidant, an activator, a tackifier, or a mixture thereof.

Embodiment 14 provides the coagulatable mixture of Embodiment 13, wherein the accelerator comprises a dithiocarbamate, a thiuram, a thiourea, a thiazol, or a mixture thereof.

Embodiment 15 provides the coagulatable mixture of any one of Embodiments 12-14, wherein the activator comprises zinc oxide.

Embodiment 16 provides the coagulatable mixture of any one of Embodiments 1-15, wherein the latex component is in a range of from about 10 wt % to about 80 wt % of the coagulatable mixture.

Embodiment 17 provides the coagulatable mixture of any one of Embodiments 1-16, wherein the latex component is in a range of from about 20 wt % to about 40 wt % of the coagulatable mixture.

Embodiment 18 provides the coagulatable mixture of any one of Embodiments 1-17, wherein the solid filler component comprises a particulate material.

Embodiment 19 provides the coagulatable mixture of Embodiment 18, wherein a largest dimension of individual particles of the particulate material is independently in a range of from about 0.10 mm to about 5 mm.

Embodiment 20 provides the coagulatable mixture of any one of Embodiments 18 or 19, wherein a largest dimension of individual particles of the particulate material is independently in a range of from about 0.25 mm to about 0.35 mm.

Embodiment 21 provides the coagulatable mixture of any one of Embodiments 18-20, wherein individual particles of the particulate material comprise a natural material, a synthetic material, or a combination thereof.

Embodiment 22 provides the coagulatable mixture of any one of Embodiments 18-21, wherein individual particles of the particulate material comprise natural rubber, synthetic rubber, poly-paraphenylene terephtalamide, Zea mays, mica, piperaceae, glitter, coffea, talc, or a mixture thereof.

Embodiment 23 provides the coagulatable mixture of any one of Embodiments 18-22, wherein individual particles of the particulate material comprise recycled rubber.

Embodiment 24 provides the coagulatable mixture of any one of Embodiments 1-23, wherein the solid filler component is in a range of from about 20 wt %/0 to about 80 wt % of the coagulatable mixture.

Embodiment 25 provides the coagulatable mixture of any one of Embodiments 1-24, wherein the solid filler component is in a range of from about 40 wt % to about 60 wt % % of the coagulatable mixture.

Embodiment 26 provides the coagulatable mixture of any one of Embodiments 1-25, further comprising a plurality of ceramic beads.

Embodiment 27 provides the coagulatable mixture of Embodiment 26, wherein the ceramic beads have a major dimension independently in a range of from about 0.10 mm to about 5 mm.

Embodiment 28 provides the coagulatable mixture of any one of Embodiments 26 or 27, wherein the ceramic beads have a largest dimension independently in a range of from about 0.25 mm to about 0.30 mm.

Embodiment 29 provides the coagulatable mixture of any one of Embodiments 1-28, wherein a pH of the mixture is in a range of from about 6 to about 8.

Embodiment 30 provides the coagulatable mixture of any one of Embodiments 1-29, wherein the mixture is substantially free of ammonium nitrate.

Embodiment 31 provides a coagulatable mixture comprising:
water;
propylene glycerol;
a latex dispersion; and
particulate Zea mays.

Embodiment 32 provides a method of making the coagulatable mixture of any one of Embodiments 1-31, the method comprising forming a mixture comprising:
the solvent component;
the latex component;
the antifreeze component; and
the solid filler component.

Embodiment 33 provides the method of Embodiment 32, wherein the latex component is added to the mixture after the solvent component, and the antifreeze component is added after the latex component.

Embodiment 34 provides a coagulated product of the coagulatable mixture of any one of Embodiments 1-31 or formed according to the method of any one of Embodiments 32 or 33.

Embodiment 35 provides a tire or tire tube comprising the coagulatable mixture of any one of Embodiments 1-34.

Embodiment 36 provides the tire or tire tube of Embodiment 35, wherein the coagulatable mixture is a liquid contacting a surface of the tire.

Embodiment 37 provides the tire or tire tube of any one of Embodiments 35 or 36, wherein a first portion of the coagulatable mixture is a liquid contacting a surface of the tire or tire tube and a second portion of the coagulatable mixture is a film evenly deposited on the surface of the tire or tire tube.

Embodiment 38 provides the tire or tire tube of any one of Embodiments 35-37, wherein the surface is an internal surface of the tire or tire tube.

Embodiment 39 provides the tire or tire tube of any one of Embodiments 35-38, wherein the tire or tire tube further comprises a rim attached to a portion of the surface.

Embodiment 40 provides the tire or tire tube of Embodiment 39, wherein the rim comprises a metal, a plastic, a composite, or a mixture thereof.

Embodiment 41 provides the tire or tire tube of any one of Embodiments 39 or 40, wherein the rim comprises chrome, aluminum, iron, mixtures thereof, or alloys thereof.

Embodiment 42 provides the tire or tire tube of any one of Embodiments 39-41, wherein the rim comprises a carbon fiber, graphite, graphene, or mixtures thereof.

Embodiment 43 provides the tire or tire tube of any one of Embodiments 39-42, further comprising an air valve extending from an external surface of the rim to a space defined between the internal surface of the tire and an internal surface of the rim or to an interior of the tube.

Embodiment 44 provides the tire or tire tube of any one of Embodiments 39-43, further comprising an air pressure sensor attached to the internal surface of the tire or tire tube or the rim.

Embodiment 45 provides the tire of any one of Embodiments 35-44, wherein the tire is a tube tire.

Embodiment 46 provides the tire of any one of Embodiments 35-45, wherein the tire is a tubeless tire.

Embodiment 47 provides the tire or tire tube of any one of Embodiments 35-46, wherein the tire or tire tube is a bicycle tire or tire tube, a motorcycle tire or tube an automobile tire or tire tube, or an aircraft tire or tire tube.

Embodiment 48 provides the tire or tire tube of any one of Embodiments 35-47, comprising the coagulated product of the coagulatable mixture of any one of Embodiments 1-31 or formed according to the method of any one of Embodiments 32 or 47.

Embodiment 49 provides the tire or tire tube of Embodiment 48, wherein the coagulated product seals one or more punctures in the tire or tire tube.

Embodiment 50 provides the tire or tire tube of Embodiment 49, wherein each of the one or more punctures independently have a major dimension in a range of from about 2 mm to about 80 mm.

Embodiment 51 provides the tire or tire tube of any one of Embodiments 49 or 50, wherein each of the one or more punctures independently have a major dimension in a range of from about 2 mm to about 8 mm.

Embodiment 52 provides the tire or tire tube of any one of Embodiments 49-51, wherein the one or more punctures are sealed in about 0.5 seconds to about 5 seconds, measured from the creation of the puncture.

Embodiment 53 provides the tire or tire tube of any one of Embodiments 49-52, wherein the one or more punctures are sealed in about 1 seconds to about 2 seconds, measured from the creation of the puncture.

Embodiment 54 provides a method of using the tire or tire tube of any one of Embodiments 49-53, the method comprising coagulating the coagulable mixture about one or more punctures in a tire or tire tube.

Embodiment 55 provides a method of making the tire or tire tube of any one of Embodiments 35-54, the method comprising disposing a quantity of the coagulatable mixture in a space formed between the interior surface of the tire and an interior surface of the rim or an interior of the tube.

Embodiment 56 provides the method of Embodiment 55, further comprising dispersing a portion the coagulatable mixture about the internal surface of the tire or tire tube.

Embodiment 57 provides the method of Embodiment 56, wherein dispersing the portion of the coagulatable mixture comprises rotating the tire or tire tube.

Embodiment 58 provides the method of Embodiment 57, wherein the tire or tire tube is rotated for about 0.5 minutes to about 240 minutes.

Embodiment 59 provides the method of any one of Embodiments 57 or 58, wherein the tire or tire tube is rotated for about 1 minute to about 20 minutes.

Embodiment 60 provides the method of any one of Embodiments 57-59, wherein the tire is rotated at a rate of from about 2 mph to about 60 mph.

Embodiment 61 provides the method of any one of Embodiments 57-60, wherein the tire is rotated at a rate of from about 20 mph to about 40 mph.

Embodiment 62 provides the tire according to any one of Embodiments 35-53 or formed according to the method of any one of Embodiments 55-61.

Embodiment 63 provides a vehicle comprising the tire of any one of Embodiments 35-53 or formed according to the method of any one of Embodiments 55-61.

Embodiment 64 provides the vehicle of Embodiment 63, wherein the vehicle is a bicycle, automobile, motorcycle, truck, or an airplane.

What is claimed is:

1. A coagulatable mixture, the mixture comprising:
a solvent component;
an antifreeze component;
a latex component; and
a solid filler component.

2. The coagulatable mixture of claim 1, wherein the solvent component is chosen from water, ammonia, turpentine, xylene, and a mixture thereof.

3. The coagulatable mixture of claim 1, wherein the solvent component is water.

4. The coagulatable mixture of claim 1, wherein the solvent component is in a range of from about 20 wt % to about 80 wt % of the coagulatable mixture.

5. The coagulatable mixture of claim 1, wherein the antifreeze component comprises methanol, glycerol, ethylene glycol, propylene glycol, propylene glycerol, or a mixture thereof.

6. The coagulatable mixture of claim 1, wherein a freezing point of the antifreeze component is in a range of from about −40° C. to about 5° C.

7. The coagulatable mixture of claim 1, wherein the antifreeze component is in a range of from about 30 wt % to about 40 wt % of the coagulatable mixture.

8. The coagulatable mixture of claim 1, wherein the latex component comprises a natural or synthetic rubber latex emulsion or dispersion.

9. The coagulatable mixture of claim 1, wherein the solid filler component comprises a particulate material.

10. The coagulatable mixture of claim 9, wherein a largest dimension of individual particles of the particulate material is independently in a range of from about 0.10 mm to about 5 mm.

11. The coagulatable mixture of claim 9, wherein individual particles of the particulate material comprise a natural material, a synthetic material, or a combination thereof.

12. The coagulatable mixture of claim 9, wherein individual particles of the particulate material comprise natural rubber, synthetic rubber, poly-paraphenylene terephtalamide, Zea mays, mica, piperaceae, glitter, coffea, talc, or a mixture thereof.

13. The coagulatable of claim 9, wherein individual particles of the particulate material comprise recycled rubber.

14. The coagulatable mixture of claim 1, further comprising a plurality of ceramic beads.

15. The coagulatable mixture of claim 14, wherein the ceramic beads have a major dimension independently in a range of from about 0.10 mm to about 5 mm.

16. The coagulatable mixture of claim 1, wherein the mixture is substantially free of ammonium nitrate.

17. A method of making the coagulatable mixture of claim 1, the method comprising forming a mixture comprising:
the solvent component;
the latex component;
the antifreeze component; and
the solid filler component.

18. The method of claim 17, wherein the latex component is added to the mixture after the solvent component, and the antifreeze component is added after the latex component.

19. A coagulated product of the coagulatable mixture formed according to the method of claim 17.

20. A tire or tire tube comprising the coagulatable mixture of claim 1.
